(19) United States
(12) Patent Application Publication
(10) Pub. No.: US 2006/0080537 A1
(43) Pub. Date: Apr. 13, 2006

(54) Illegal analysis / falsification preventing system

(75) Inventor: Tetsuya Yoshizaki, Nagaokakyo-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/244,081

(22) Filed: Oct. 6, 2005

(30) Foreign Application Priority Data
Oct. 7, 2004 (JP) 2004-295208

(51) Int. Cl. H04L 9/00

(52) U.S. Cl. 713/176

(57) ABSTRACT

A hash function operation system comprises a hash function operation processing device comprising a plurality of hash function operation units connected in multiple stages and incapable of predicting an output from an input, an illegal access detecting device for detecting an illegal access, and an illegal access monitoring device for retrieving an output of an optional stage in a sequence of processings executed by the hash function operation units and inputting the retrieved output to the hash function operation unit in the next stage when the illegal access detecting device shows a state where the illegal access is not detected, the illegal access monitoring device further applying a disturbance to the retrieved output when the illegal access detecting device shows a state where the illegal access is detected and inputting the resulting output to the hash function operation unit in the next stage, wherein falsification is prevented and an encryption key is safely generated by executing the different hash function operations depending on the state of the illegal access.

### FIELD OF THE INVENTION

The present invention relates to a system for preventing an illegal analysis and falsification of a computer program and data conducted by a third party.

### BACKGROUND OF THE INVENTION

As a conventional technology of preventing any illegal analysis and falsification of a system program and data to desirably remain confidential in a set of built-in products by an unidentified user using a debugger or the like were available a system for restricting an access to an analyzing apparatus (debugger or the like) and a system for encrypting a subject of confidentiality.

In the system for restricting the access to the analyzing apparatus, a software controls whether or not the analyzing apparatus can be used as recited in, for example, No. 2000-347942 of the Publication of the Unexamined Japanese Patent Applications. The disclosure of the aforementioned document is that: any access to the confidential data by the unidentified user is restricted by prohibiting the use of the debugger at the time of power-on reset; and the access restriction at the time of the power-on reset is cancelled in the case of an identified user who is allowed to access the confidential data by activating a software including a cancellation code.

In the system for encrypting the subject of confidentiality, as recited in No. H11-328032 of the Publication of the Unexamined Japanese Patent Applications, the data to be protected is encrypted, and further, a key data is changed into a dummy data when an illegal access is detected. The disclosure of the aforementioned document is that: the presence/absence of the illegal access is detected when an encryption key for decoding the confidential data is read; the confidential data is decoded irrespective of the presence/absence of the illegal access; the confidential data is re-encrypted after any necessary processing is executed; the encryption key used for the re-encryption is changed into, not a regular key, but the dummy data, when the illegal access is detected and stored in a predetermined memory region; and the decoding is not normally executed when the access is thereafter made to the confidential data because the encryption key is the dummy data.

The fact is that a sufficient security level is not assured in the conventional technology for preventing the illegal analysis and falsification of the system program and data to be confidentially protected in the set of built-in products by the unidentified user using the debugger or the like.

The system for setting the access restriction with respect to the analyzing apparatus (debugger or the like) limits its range of the prevention to the single analyzing apparatus. Therefore, it is difficult to apply the system to any other analyzing apparatus such as a wiring probing or the like, and the security level is insufficient. Further, the software is in charge of controlling whether or not the analyzing apparatus can be used, which makes it necessary to secrete a method of activating the program including the code for the allowance of the use. Therefore, the system includes a weakness that the security is easily violated in that regard.

In the system for encrypting the confidential subject, the regular encryption key is left in the memory or file in such manner the it can be easily encrypted by the debugger or the like, which does not provide the sufficient security level. Provided that the regular encryption key itself is also confidentially protected by some kind of means, the conventional technology lacks a solution for how the regular key should be handled, as an example of which, there is no arrangement for the protection of the regular encryption key immediately before it is used for the decoding process. Further, a solution for the disadvantage that plain-text data resulting from the decoded encrypted data can be dynamically analyzed by the debugger or the like is not included either.

### SUMMARY OF THE INVENTION

Therefore, a main object of the present invention is to provide a system applicable to illegal accesses of different types and manners, capable of safely controlling switchover between effective and ineffective of a state of a security assurance, preventing any illegal analysis/falsification of a system program and data to be confidentially protected conducted by an unidentified user using a debugger or the like and safely executing an encrypting process and a decoding process.

According to the present invention, an encryption key can be safely managed and data falsification can be prevented from being falsified by a hash function operation system that detects an illegal access and changes its actuation depending on a state the detection. The present invention is effectively used for preventing the illegal analysis and the illegal falsification of a program and data, and further, can be utilized for a video/musical device for handing contents whose copyright is to be protected and a database system, IC card and the like in which security information such, as personal information and monetary information, is handled.

In order to achieve the foregoing object, a hash function operation system according to the present invention comprises:

a hash function operation processing device comprising a plurality of hash function operation units connected in multiple stages and adapted in such manner that information lengths of an inputted value for operation and a value resulting from the operation are equal to each other and the inputted value for operation and the value resulting from the operation correspond to each other based on 1:1;

an illegal access detecting device for detecting an illegal access from outside when the hash function operation processing device executes an operation;

an illegal access monitoring device for retrieving an output of an optional stage in a sequence of processings executed by the hash function operation units connected in the multiple stages and inputting the retrieved output to the hash function operation unit in the next stage when the illegal access detecting device shows a state where the illegal access is not detected, the illegal access monitoring device further applying a disturbance to the retrieved output when the illegal access detecting device shows a state where the illegal access is detected and inputting the resulting output to the hash function operation unit in the next stage.

In the foregoing constitution, each of the hash function operation units is a function operation unit adapted in such manner that the information lengths of the input and the output are equal to each other, and the output cannot be predicted from the input.

As a preferable mode of the foregoing hash function operation processing device, the hash function operation processing device comprises:

a previous-stage hash function operation processing device comprising at least a hash function operation unit serially connected, the previous-stage hash function operation processing device transmitting an output of the hash function operation unit in a final stage to the illegal access monitoring device; and

a latter-stage hash function operation processing device comprising at least a hash function operation unit serially connected, the latter-stage hash function operation processing device inputting a signal transmitted from the illegal access monitoring device to the hash function operation unit in a foremost stage and outputting an operation result obtained by the hash function operation unit in the final stage outside.

According to the foregoing constitution, the different hash function operations are executed with respect to the normal access and the illegal access so that the illegal access such as an illegal debugger analysis can be flexibly handled. The foregoing constitution merely focuses on the detection of the illegal access, and the hash function operation is therefore changed depending on whether or not the illegal access is/is not detected irrespective of a type of the illegal access. As a result, the illegal accesses of various types can be flexibly handled. Further, a person responsible for the illegal access can hardly know the change of the hash function operation in response to the illegal access because of the applied disturbance.

As a preferable mode of the illegal access monitoring device, a disturbance different to the disturbance applied in the detected state is applied to the retrieved output when the illegal access detecting device shows the not-detected state, and the resulting output is inputted to the hash function operation unit in the next stage.

According to the foregoing constitution, the disturbance is applied also when the illegal access is not detected. Thereby, the actuation analysis is made impossible even if the data communicated between the hash function operation processing device and the illegal access monitoring device is illegally glanced at. Therefore, in such a structure that the hash function operation processing device and the illegal access monitoring device are separately provided on different semiconductor chips and wiring-combined, the illegal analysis can be avoided because of a wiring probing or the like, thereby assuring the safety.

As a preferable mode of the illegal access detecting device, the illegal access detecting device is adapted in such manner that the not-detected state shifts to the detected state or the detected state shifts to the not-detected state using a history of the illegal accesses since the system is activated.

According to the foregoing constitution, the illegal access detecting device can be actuated at different levels corresponding to degrees of influence brought on the system by the various illegal accesses. Further, the foregoing constitution can be utilized for complicating regular procedures for analyzing the debugging and fault in a set of built-in products by making such an arrangement that the judgment of the illegal access is rendered when the debugger is connected after a case of the set of built-in products is unsealed and the judgment of the illegal access is not rendered when the case of the set of built-in products is unsealed after the debugger is connected.

In the hash function operation system according to the present invention constituted above, the illegal access monitoring device preferably comprises a password memorizing unit for memorizing passwords and a password comparing unit for comparing the output of the illegal access monitoring device to the passwords of the password memorizing unit, wherein the actuation of the illegal access detecting device is adapted to switch to and from a constantly detected state, a constantly not-detected state and an illegal access detected state depending on a state of correspondence between the passwords and the output.

According to the foregoing constitution, the actuation of the illegal access detecting device is switched to and from the constantly detected state, constantly not-detected state and illegal access detected state depending on the correspondence or non-correspondence between the passwords and the output, in other words, using chronological data inputted to the hash function operation processing device. Therefore, the state of security assurance can be selectively made effective or ineffective in a safe manner. For example, a debugging work in a product development process and an analyzing work on a failed product can be reduced.

As a preferable mode of the illegal access monitoring device, the passwords are compared to the output when the output of the illegal access monitoring device is stored/memorized to such an extent that an optional information length is reached.

In the foregoing constitution, a complicated data pattern can be used as the password, which minimizes possible weaknesses in using the password.

In the hash function operation system according to the present invention, the hash function operation processing device preferably further comprises a hash function output memorizing unit for retrieving and memorizing the output from the hash function operation unit in an optional stage and a feedback operation unit for executing an optional operation to the memorized output and the input of the hash function operation unit in the previous stage closer to the input than the output in the stage of the memorized output.

In the foregoing constitution, there is no restriction to the information length used as the input of the hash function operation. Thereby, the output having a fixed length can be obtained with respect to the input having an optional information length. In particular, the falsification of a long text can be detected, and the encryption key can be generated based on the long-text data. The feedback operation unit employs a system in which a feedback data is subjected to the operation with the input of the hash function operation unit and a result of the operation is used as the input of the relevant hash function operation unit and a system in which the feedback data is set as an initial operation parameter of the hash function operation unit and the operation of the relevant hash function operation unit is changed. Because the different hash function operation is thereby executed for each feedback, it becomes more difficult to predict the hash function operation result than in the case of executing a single hash function operation, which increases the security level.

In the hash function operation system according to the present invention, the hash function operation processing device preferably further comprises an initial operation parameter memorizing unit for memorizing an initial operation parameter used for the hash function operation other than the input and the output, a hash function output memorizing unit for retrieving and memorizing the output of the hash function operation unit in an optional stage and a feedback operation memorizing unit for executing an optional operation to the memorized output and the initial operation parameter of the hash function operation unit in the previous stage closer to the input than the output in the stage of the memorized output and memorizing a result of the operation as a renewed initial operation parameter.

In the hash function operation system according to the present invention, the hash function operation unit is preferably adapted to include an inverse function for obtaining an input from an output based on 1:1 and be capable of executing an inverse operation by obtaining an input from an output of a hash function inverse operation processing device.

An encryption system according to the present invention comprises:

a hash function inverse operation processing device capable of executing an inverse operation and comprising a plurality of hash function inverse operation units connected in multiple stages, the hash function inverse operation units performing an inverse function relative to the hash function operation units; and

an illegal access monitoring device for retrieving an output of an optional stage in a sequence of processings executed by the hash function inverse operation units connected in the multiple stages and inputting the retrieved output to the hash function inverse operation unit in the next stage in a state where an illegal access is not detected, the illegal access monitoring device further applying a disturbance to the retrieved output in a state where the illegal access is detected and inputting the resulting output to the hash function inverse operation unit in the next stage.

In the foregoing constitution, any person who knows an inverse operation method can generate the input in such manner that plan-text data readably by a human can be outputted though the inputted data is unreadable. Therefore, the encryption system in which no encryption key or decoding key is demanded can be provided.

An illegal analysis/falsification preventing system according to the present invention comprises:

a confidential data memorizing device for memorizing a program or data to be confidentially protected;

an encryption key generation data memorizing device for memorizing a source data (seed) for generating an encryption key used in a symmetry encryption system;

a hash function operation system according to any of the aforementioned constitutions, the hash function operation system inputting the data of the encryption key generation data memorizing device and generating the encryption key using the hash function operation; and

a symmetry encrypting apparatus for encrypting the data or program to be confidentially protected in the confidential data memorizing device by means of the symmetry encryption system using the encryption key obtained from the hash function operation system.

In the foregoing constitution, the regular encryption key is not generated when the illegal access is detected, while the regular encryption key is generated when the illegal access is not detected so that the safety of the program and data to desirably remain confidential can be increased. Further, the source data for generating the encryption key can be left in the memory or file, which makes the confidential management of the encryption key unnecessary.

To describe the symmetry encryption system, the same key is used for the encryption and decoding. In contrast to that, the different keys are used for the encryption and decoding in an asymmetry encryption system.

An illegal analysis/falsification preventing system according to the present invention comprises:

an encrypted data memorizing device for memorizing symmetry-encrypted data;

a decoding key generation data memorizing device for memorizing a source data (seed) for generating a decoding key used for a decoding process by means of the symmetry encryption system;

a hash function operation system according to any of the aforementioned constitutions, the hash function operation system inputting the data of the decoding key generation data memorizing device and generating the decoding key using the hash function operation; and

a symmetry encryption decoding apparatus for decoding the encrypted data of the encrypted data memorizing device by means of the symmetry encryption system using the decoding key obtained from the hash function operation system.

In the foregoing constitution, the regular decoding key is not generated when the illegal access is detected, while the regular decoding key is generated when the illegal access is not detected so that the program and data to be confidentially protected can be safely decoded. Further, the source data for generating the decoding key can be left in the memory or file, which makes the confidential management of the decoding key unnecessary.

An illegal analysis/falsification preventing system according to the present invention comprises:

a confidential data memorizing device for memorizing a program or data to be confidentially protected;

a security parameter generation data memorizing device for memorizing a source data (seed) for generating a security parameter used for generating a pair of keys in the asymmetry encryption system;

a hash function operation system according to any of the aforementioned constitutions, the hash function operation system inputting the data of the security parameter generation data memorizing device and generating the security parameter using the hash function operation;

an encryption key generating device for generating an encryption key based on the security parameter using the hash function operation system, the encryption key generating device generating the encryption key by selecting or fixing one of a public key and a secret key based on a user's input or initial settings; and

an asymmetry encrypting apparatus for encrypting the data or program to be confidentially protected in the confidential data memorizing device by means of the asymmetry encryption system using the encryption key obtained from the encryption key generating device.

In the foregoing constitution, one of the encrypting function and the decoding function is limitedly employed in the same system because the asymmetry encryption system is used. Therefore, the decoded data, even if illegally retrieved, cannot be falsified and re-encrypted in the system. As a result, the system itself can be prevented from being illegally modified because the decoded data cannot the falsified and re-encrypted in the system though the decoded data is illegally retrieved.

An illegal analysis/falsification preventing system according to the present invention comprises:

an encrypted data memorizing device for memorizing asymmetry-encrypted data;

a confidential data memorizing device for memorizing a program or data to be confidentially protected;

a security parameter generation data memorizing device for memorizing a source data (seed) for generating a security parameter used for generating a pair of keys in the asymmetry encryption system;

a hash function operation system according to any of the foregoing constitutions, the hash function operation system inputting the data of the security parameter generation data memorizing device and generating the security parameter using the hash function operation;

a decoding key generating device for generating a decoding key based on the security parameter obtained by the hash function operation system, the decoding key generating device generating the decoding key by selecting or fixing one of a public key and a secret key based on a user's input or initial settings; and

an asymmetry encryption decoding apparatus for decoding the data or program to be confidentially protected in the confidential data memorizing device by means of the asymmetry encryption system using the decoding key obtained from the decoding key generating device.

In the foregoing constitution, one of the encrypting function and the decoding function is limitedly employed in the same system because the asymmetry encryption system is used. Therefore, the decoded data, even if illegally retrieved, cannot be falsified and re-encrypted in the system. As a result, the system itself can be prevented from being illegally modified because the decoded data cannot the falsified and re-encrypted in the system though the decoded data is illegally retrieved.

The illegal analysis/falsification preventing system constituted as described above preferably further comprises a system analysis control device for accepting or rejecting the system analyzing apparatus such as the debugger or tracer and using program data as the source data for generating the encryption key used for the symmetry encryption system, the program data including codes for controlling the acceptance or rejection of the system analyzing apparatus therein.

The illegal analysis/falsification preventing system constituted as described above preferably further comprises a system analysis control device for accepting or rejecting the system analyzing apparatus such as the debugger or tracer and using program data as the source data for generating the decoding key used for the decoding process by means of the symmetry encryption system, the program data including codes for controlling the acceptance or rejection of the system analyzing apparatus therein.

The illegal analysis/falsification preventing system constituted as described above preferably further comprises a system analysis control device for accepting or rejecting the system analyzing apparatus such as the debugger or tracer and using program data as the source data for generating the security parameter used for the asymmetry encryption system, the program data including codes for controlling the acceptance or rejection of the system analyzing apparatus therein.

The illegal analysis/falsification preventing system constituted as described above preferably further comprises a system analysis control device for accepting or rejecting the system analyzing apparatus such as the debugger or tracer and using program data as the source data for generating the security parameter used for the decoding process by means of the asymmetry encryption system, the program data including codes for controlling the acceptance or rejection of the system analyzing apparatus therein.

In the respective constitutions described above, the access control code for the system analyzing apparatus such as the debugger is included in the system program whose security is assured as a result of the respective constitutions described so far, thereby preventing the falsification. As a result, the system analyzing apparatus such as the debugger can be deactivated in advance and the data can be thereby safely encrypted when the confidential data generated in the process of executing the system program is encrypted. Further, the restriction can be provided for the illegal analysis and illegal falsification with respect to the plan-text data obtained by decoding the encrypted data, which enables the protection of the plain-test data resulting from the normal decoding of the encrypted confidential data.

### BRIEF DESCRIPTION OF THE DRAWINGS

The present invention is illustrated be way of example and not limitation in the figures of the accompanying drawings, in which like references indicate similar elements.

FIG. 1 is a block diagram illustrating a constitution of a hash function operation system according to a first preferred embodiment of the present invention.

FIG. 2 is a block diagram illustrating a constitution of a hash function operation system according to a second preferred embodiment of the present invention.

FIG. 3 is a block diagram illustrating a constitution of a hash function operation system according to a third preferred embodiment of the present invention.

FIG. 4 is a block diagram illustrating a constitution of a hash function operation system according to a fourth preferred embodiment of the present invention.

FIG. 5 is a block diagram illustrating a constitution of a hash function operation system according to a fifth preferred embodiment of the present invention.

FIG. 6 is a block diagram illustrating a constitution of a hash function operation system (decoding apparatus) according to a sixth preferred embodiment of the present invention.

FIG. 7 is a block diagram illustrating a constitution of a hash function operation system (encrypting apparatus) according to the sixth preferred embodiment.

FIG. 8 is a block diagram illustrating a constitution of an illegal analysis/falsification preventing system (encrypting apparatus) according to a seventh preferred embodiment of the present invention.

FIG. 9 is a block diagram illustrating a constitution of an illegal analysis/falsification preventing system (decoding apparatus) according to the seventh preferred embodiment.

FIG. 10 is a block diagram illustrating a constitution of an illegal analysis/falsification preventing system (encrypting apparatus) according to an eighth preferred embodiment of the present invention.

FIG. 11 is a block diagram illustrating a constitution of an illegal analysis/falsification preventing system (decoding apparatus) according to the eighth preferred embodiment.

FIG. 12 is a block diagram illustrating a constitution of an illegal analysis/falsification preventing system (encrypting apparatus) according to a ninth preferred embodiment of the present invention.

FIG. 13 is a block diagram illustrating a constitution of an illegal analysis/falsification preventing system (decoding apparatus) according to the ninth preferred embodiment.

### DETAILED DESCRIPTION OF THE INVENTION

Hereinafter, preferred embodiments of the present invention are described referring to the drawings.

### First Preferred Embodiment

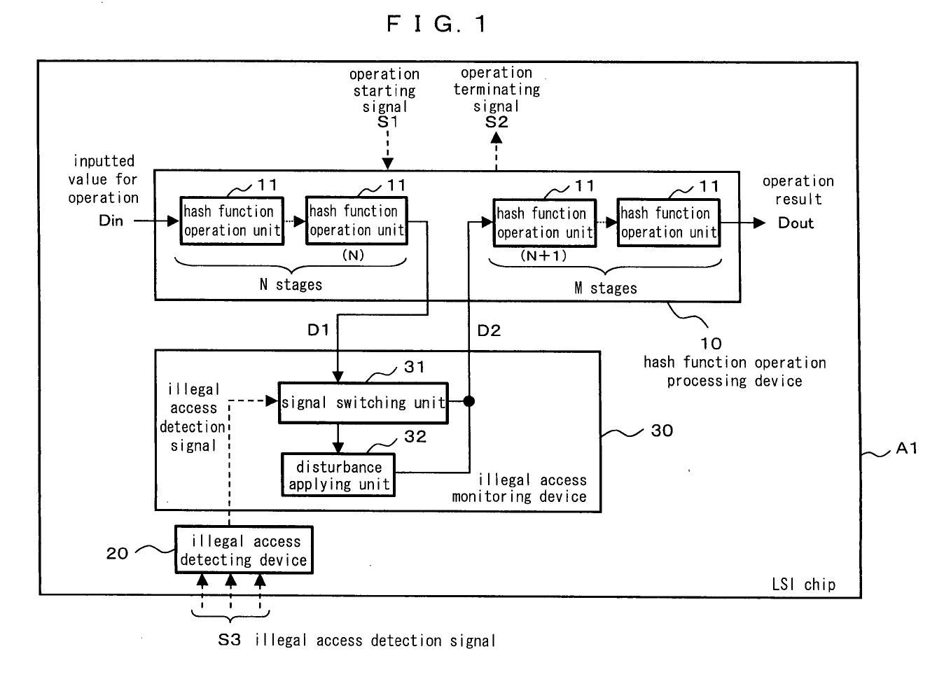

FIG. 1 is a block diagram illustrating a constitution of a hash function operation system according to a first preferred embodiment of the present invention. Referring to reference numerals shown in FIG. 1, 10 denotes a hash function operation processing devices 20 denotes an illegal access detecting device and 30 denotes an illegal access monitoring device.

In the hash function operation processing device 10, information lengths of an input and an output are equal to each other and a relationship between the input and the output is 1:1, and further, a plurality of hash function operation units 11 incapable of predicting the output from the input is connected in multiple stages.

The illegal access detecting device 20 inputs a plurality of illegal access detection signals S3 and executes a logical operation (logical sum, logical multiplication or the like) thereto so that the presence/absence of an illegal access in the hash function operation processing device 10 at the time of executing the operation is detected and a result of the detection is supplied to the illegal access monitoring device 30 as an illegal access detection signal S4. Examples of the illegal access detection signal S3 include a debugger connection signal, a signal that becomes effective when a case of a set of built-in products is opened and the like.

The illegal access monitoring device 30 comprises a signal switching unit 31 and a disturbance applying unit 32. The signal switching unit 31 retrieves an output in an optional stage in a sequence of processings executed by the hash function operation units 11 connected in the multiple stages in the hash function operation processing device 10. Then, the signal switching unit 31 outputs the retrieved output to the hash function operation unit 11 in the next stage when the illegal access detection signal S4 from the illegal access detecting device 20 is ineffective (illegal access is not detected), while outputting the retrieved output to the disturbance applying unit 32 when the illegal access detection signal S4 is effective (illegal access is detected). The disturbance applying unit 32 applies a disturbance to the retrieved output, and thereafter outputs the resulting output to the hash function operation unit 11 in the next stage.

In the present embodiment, the hash function operation processing device 10, illegal access detecting device 20 and illegal access monitoring device 30 are incorporated in an LSI chip A1 in which a system program is actuated.

An actuation of the hash function operation system according to the present embodiment is described below.

The input and output of the hash function operation processing device 10 is, for example, an input and an output in a register mapped in a memory address space accessible based on 32-bit data by the system program. The hash function operation processing device 10 accepts the input of an operation starting signal S1 as a trigger for starting the operation and outputs an operation terminating signal S2 for allowing an output register to be read when the operation is terminated.

When the hash function operation is used, an inputted value for operation Din is set in an input register by the system program so that the operation starting signal S1 becomes effective. When the operation starts, the inputted operation value Din is inputted to the hash function operation unit 11 in the first stage. The output of the hash function operation unit 11 in the first stage is inputted to the hash function operation unit 11 in the next stage. Thus, the operations of the hash function operation units 11 are serially executed. When the operations up to an optional stage N are terminated, the output of the hash function operation unit 11 in the Nth stage is inputted to the illegal access monitoring device 30 (input signal D1).

In the illegal access detecting device 20, the signal switching unit 31 uses a composite signal resulting from the logical sum, logical multiplication or the like of the multiple illegal access detection signals S3 as the illegal access detection signal S4.

The illegal access monitoring device 30 directly uses the input signal D1 as an output signal D2 of the illegal access monitoring device 30 when the illegal access detection signal S4 from the illegal access detecting device 20 is ineffective (illegal access is not detected). When the illegal access detection signal S4 from the illegal access detecting device 20 is effective (illegal access is detected), the input signal D1 is outputted to the disturbance applying unit 32, and a result obtained by applying the disturbance to the input signal D1 in the disturbance applying unit 32 is used as the output signal D2 of the illegal access monitoring device 30.

Next, the output signal D2 of the illegal access monitoring device 30 is returned to the hash function operation processing device 10 and inputted to the hash function operation unit 11 in an (N+1) th stage. The output of the hash function operation unit 11 in the (N+1) th stage is inputted to the hash function operation unit 11 in the next stage, and the operations of the hash function operation units 11 in an M number of stages are serially executed. The output of the hash function operation unit 11 in the final stage is the output of the hash function operation processing device 10. Then, an operation result Dout is set in the output register, and the operation terminating signal S2 is communicated to the system program.

According to the present embodiment, the inputted value Din results in the different outputs depending on the state of the illegal access because the different hash function operations are executed at the time of the normal access and at the time of the illegal access. Therefore, an encrypting apparatus in response to the illegal access such as the illegal debugger analysis or the like and a hash function operation system usable for a falsification detecting apparatus can be provided.

Further, because the system is used only when the illegal access is detected, the illegal accesses of different types can be flexibly handled, and the different states of the illegal access can be handled because the composite signal resulting from the logical sum, logical multiplication or the like of the multiple illegal access detection signals S3 can be used as the illegal access detection signal S4.

### Second Preferred Embodiment

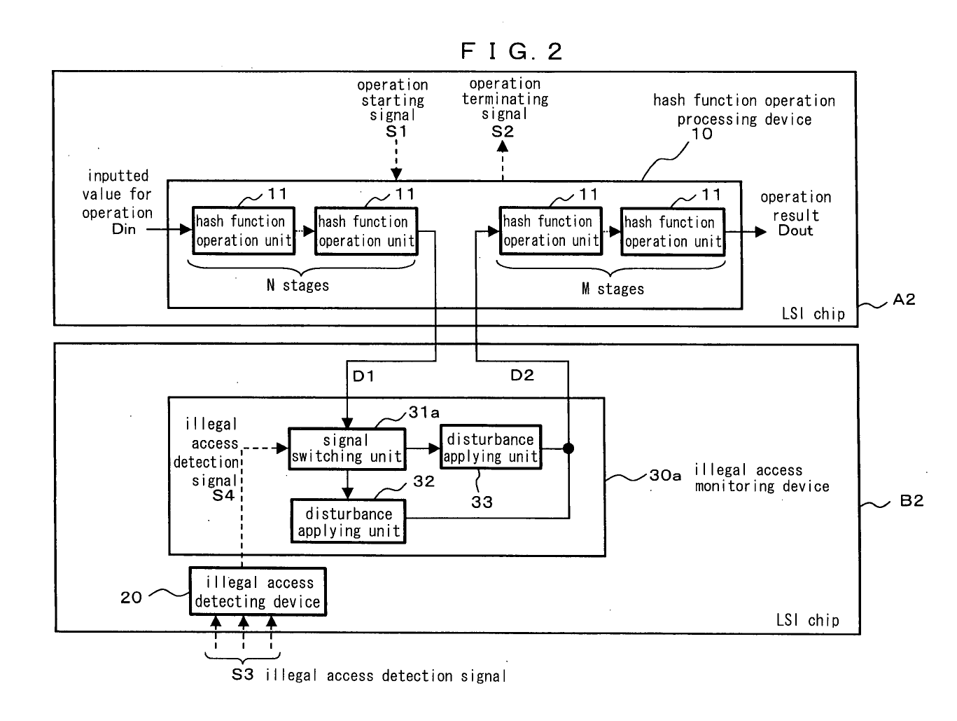

FIG. 2 is a block diagram illustrating a constitution of a hash function operation system according to a second preferred embodiment of the present invention. In the present embodiment, an illegal access monitoring device 30a is differently constituted in comparison to the first preferred embodiment shown in FIG. 1. In FIG. 2, the constitutions of the hash function operation processing device 10 and the illegal access detecting device 20 are the same as described in the first preferred embodiment.

The illegal access monitoring device 30a comprises two disturbance applying units 32 and 33 and a signal switching unit 31a. The signal switching unit 31a outputs the input signal D1 to the disturbance applying unit 33 when the illegal access detection signal S4 is ineffective, while outputting the input signal D1 to the disturbance applying unit 32 when the illegal access detection signal S4 is effective. The disturbance applying unit 32 and the disturbance applying unit 33 respectively apply different disturbances. More specifically, the disturbance is applied to the input signal D1 being serially subjected to the hash function operations irrespective of the presence/absence of the illegal access in the present embodiment.

In the present embodiment, the hash function operation processing device 10 is incorporated in an LSI chip A2 in which the system program is actuated. The illegal access detecting device 20 and the illegal access monitoring device 30a are separately mounted on an LSI chip B2 different to the LSI chip A2, wherein they are wiring-combined.

An actuation of the hash function operation system according to the present embodiment is described below.

In the illegal access monitoring device 30a, the signal switching unit 31a outputs the input signal D1 to the disturbance applying unit 33 when the illegal access detection signal S4 from the illegal access detecting device 20 is ineffective (illegal access is not detected), and outputs a result obtained by applying the disturbance using the disturbance applying unit 33 as the output signal D2 of the illegal access monitoring device 30a. The signal switching unit 31a outputs the input signal D1 to the disturbance applying unit 32 when the illegal access detection signal S4 from the illegal access detecting device 20 is effective (illegal access is detected), and outputs a result obtained by applying the disturbance using the disturbance applying unit 32 as the output signal D2 of the illegal access monitoring device 30a. The rest of the actuation, which is the same as described in the first preferred embodiment, is not described here again.

According to the present embodiment, in addition to the effect obtained in the first preferred embodiment, the disturbance is applied even when the illegal access is not detected by the illegal access detecting device 20 so that the actuation cannot be analyzed even if the data communicated between the illegal access monitoring device 30a and the hash function operation processing device 10 is illegally glanced at. Because of that, the illegal analysis is not possible because of a wiring probing or the like in the structure where the hash function operation processing device 10 and the illegal access monitoring device 30a are separately mounted and wiring-combined on the different chips A2 and B2.

### Third Preferred Embodiment

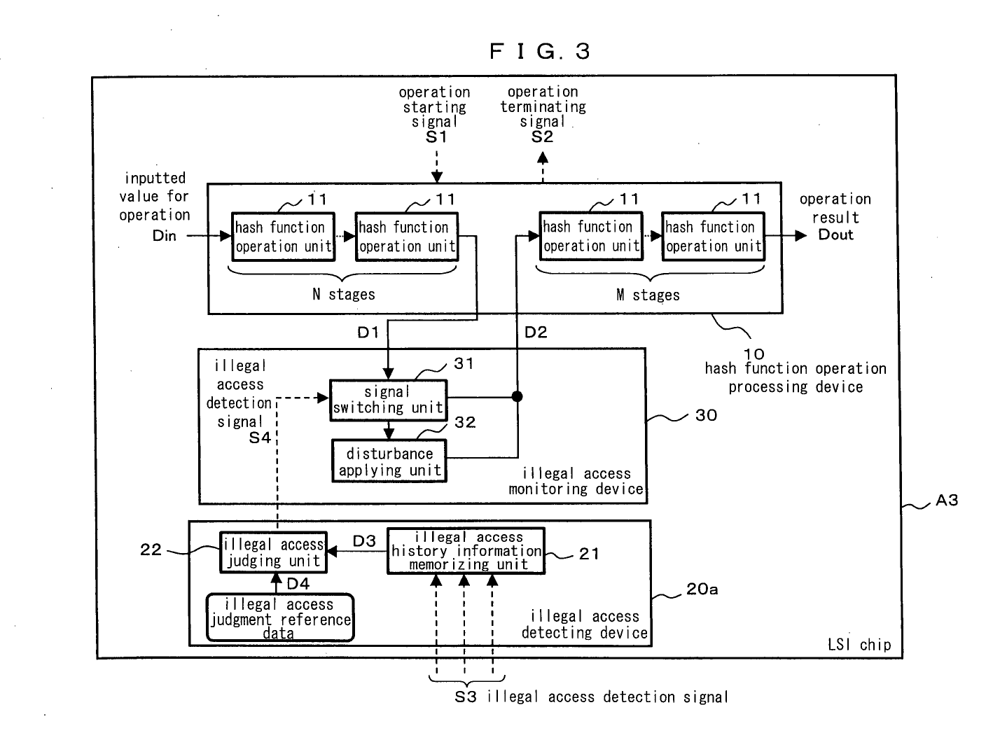

FIG. 3 is a block diagram illustrating a constitution of a hash function operation system according to a third preferred embodiment of the present invention. The present embodiment is different to the first preferred embodiment shown in FIG. 1 in a constitution of an illegal access detecting device 2Oa. In FIG. 3, the constitutions of the hash function operation processing device 10 and the illegal access monitoring device 30 are the same as described in the first preferred embodiment.

The illegal access detecting device 20a comprises an illegal access history information memorizing unit 21 for memorizing an illegal access history information obtained since the system is activated and an illegal access judging unit 22 for comparing a history information D3 memorized in the illegal access history information memorizing unit 21 to an illegal access judgment reference data D4 previously set and switching to and from the not-detected state and the detected state depending on the correspondence/non-correspondence between the compared data.

In the present embodiment, the hash function operation processing device 10, illegal access detecting device 20a and illegal access monitoring device 30 are incorporated in an LSI chip A3 in which the system program is actuated.

The illegal access detecting device 20 according to the second preferred embodiment shown in FIG. 2 may be replaced with the illegal access detecting device 20a according to the present embodiment.

An actuation of the hash function operation system according to the present embodiment is described below.

In the illegal access detecting device 20a, the illegal access history information memorizing unit 21 memorizes the history information of the multiple illegal access detection signals S3 obtained since the system is activated. The illegal access judging unit 22 compares the history information D3 memorized in the illegal access history information memorizing unit 21 to the illegal access judgment reference data D4 previously set every time when the states of the multiple illegal access detection signals S3 are changed, and switches to and from the not-detected state and the detected state depending on the correspondence/non-correspondence between the compared data, and further, outputs the illegal access detection signal S4 in accordance with the correspondence/non-correspondence.

For example, the mere connection of the debugger is not regarded as the illegal access, and the judgment of the illegal access is rendered when the debugger is connected after the case of the set of built-in products is unsealed. Further, the judgment of the illegal access can be controlled depending on in what order the illegal access is made, an example of which is that the illegal access is not detected when the case of the set of built-in products is unsealed after the debugger is connected. The rest of the actuation, which is the same as described in the first preferred embodiment, is not described here again.

According to the present embodiment, the history information of the multiple illegal access detection signals S3 obtained since the system is activated is used in order to judge the detection of the illegal access conducted by the illegal access detecting device 20a. Therefore, each of the various illegal accesses can be flexibly handled at the different levels in accordance with a degree of influence inflicted by the illegal access to the system. Further, it can be arranged that the judgment of the illegal access is rendered when the debugger is connected after the case of the built-in products is unsealed and the judgment of the illegal access is not rendered when the case of the built-in products is unsealed after the debugger is connected, which can be utilized for complicating regular procedures for analyzing the debug and fault in the set of built-in products.

### Fourth Preferred Embodiment

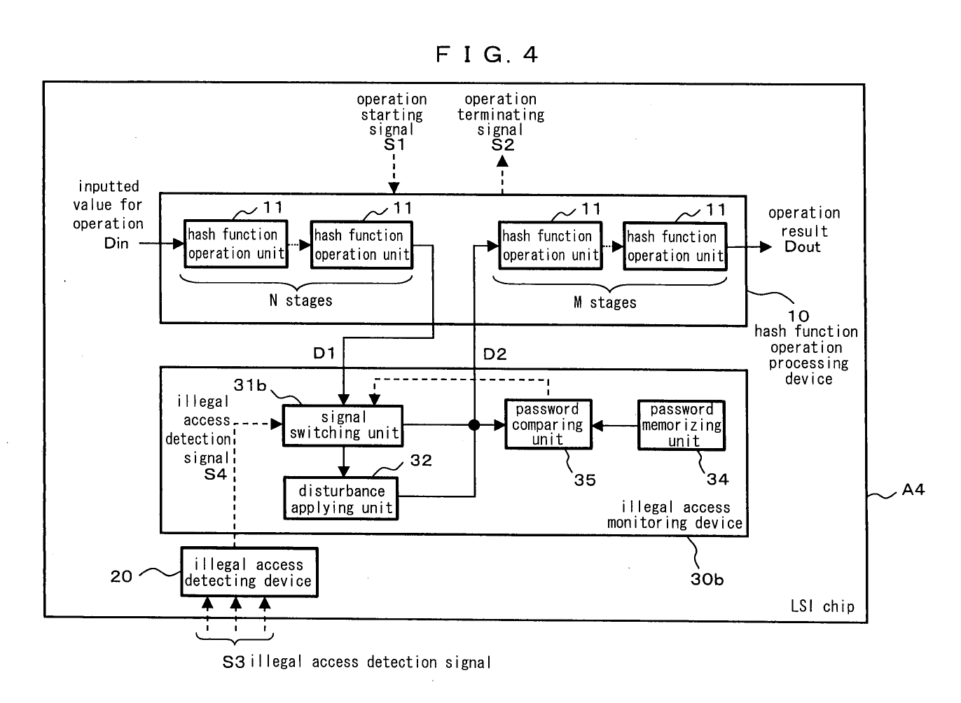

FIG. 4 is a block diagram illustrating a constitution of a hash function operation system according to a fourth preferred embodiment of the present invention. The present embodiment is different to the first preferred embodiment shown in FIG. 1 in a constitution of an illegal access monitoring device 30a. In FIG. 4, the constitutions of the hash function operation processing device 10 and the illegal access detecting device 20 are the same as described in the first preferred embodiment.

The illegal access monitoring device 30b comprises, in addition to the signal switching unit 31b and the disturbance applying unit 32 constituted in the same manner as in the first preferred embodiment, a password memorizing unit 34 for memorizing predetermined passwords and a password comparing unit 35 for comparing the output of the illegal access monitoring device 30b to the passwords of the password memorizing unit 34 and switching the actuation of the signal switching unit 31b to and from a constantly detected state, a constantly not-detected state and an illegal access detected state (state where the actuation is automatically switched in accordance with the signal of the illegal access detecting device 20) depending on the correspondence/non-correspondence between the output and the password. The password comparing unit 35 has a function of comparing the output to the password after the outputs to be compared to the passwords are stored/memorized until an optional information length is reached. An example of a storing/memorizing device thereof is an FIFO buffer that memorizes the data in a chronological order and discards the data, the oldest data first.

In the present embodiment, the hash function operation processing device 10, illegal access detecting device 20 and illegal access monitoring device 30b are incorporated in an LSI chip A4 in which the system program is actuated.

The illegal access monitoring device 30b comprising the password memorizing unit 34 and the password comparing unit 35 may be applied to the other preferred embodiments.

An actuation of the hash function operation system according to the present embodiment is described below.

The password comparing unit 35 of the illegal access monitoring device 30b stores/memorizes the output signal D2 in the FIFO buffer thereof until the optional information length is reached. Then, the password comparing unit 35 compares the data in the FIFO buffer to the passwords previously memorized in the password memorizing unit 34, and sets the actuation of the actuation of the signal switching unit 30b, for example, to the constantly detected state when the data corresponds to the password for shifting to the constantly detected state.

When the data in the FIFO buffer corresponds to the password for shifting to the constantly not-detected state or the password for shifting to the illegal access detected state, the actuation of the signal switching unit 31b is switched to one of the respective states.

The FIFO buffer can be flexibly set in such manner that only the incoming data odd-numbered in the chronological order is stored.

The rest of the actuation, which is the same as described in the first preferred embodiment, is not described here again.

According to the present embodiment, the system program uses the chronological data inputted to the hash function operation processing device 10 to thereby switch to and from ineffective and effective of the function of handling the illegal access. As a result, a debugging work in a product development process and an analyzing work of a failed product, for example, can be reduced.

Further, when the method of storing the chronological data in the password comparing unit 35 is improved, a level of integrity of the password can be variously changed, which realizes a desired security level.

### Fifth Preferred Embodiment

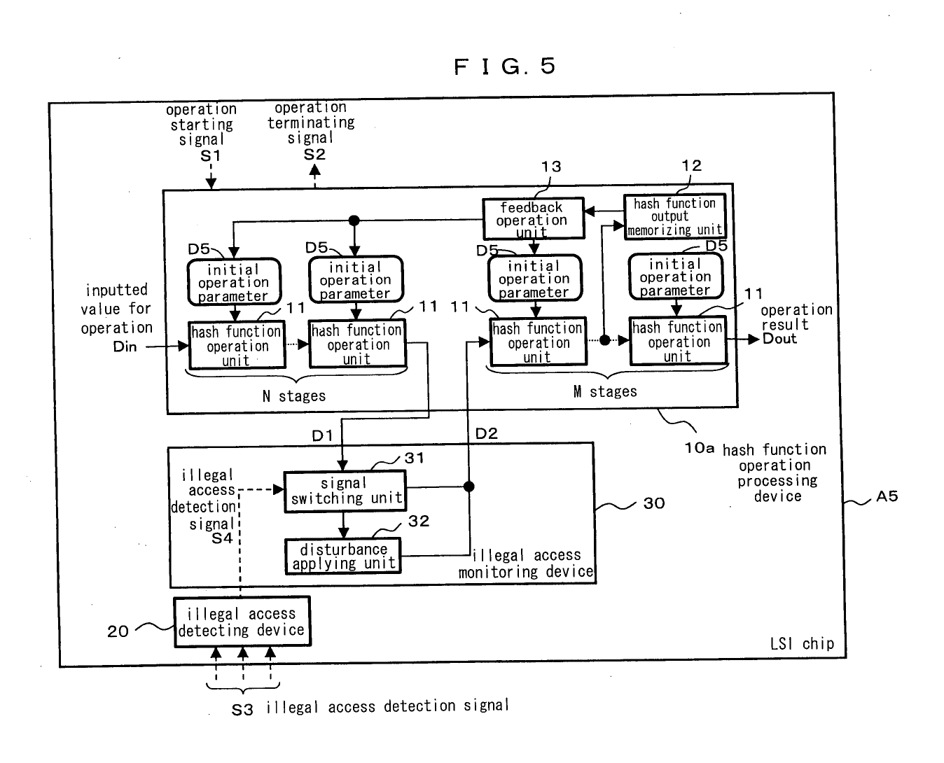

FIG. 5 is a block diagram illustrating a constitution of a hash function operation system according to a fifth preferred embodiment of the present invention. In the present embodiment, a constitution of a hash function operation processing device 10a is different in comparison to the first preferred embodiment shown in FIG. 1. In FIG. 5, the illegal access monitoring device 30 and the illegal access detecting device 20 are constituted in the same manner as described in the first preferred embodiment.

The hash function operation processing device 10a comprises a hash function output memorizing unit 12 for retrieving and memorizing the output of the hash function operation unit 11 in an optional stage in the respective hash function operation units 11 connected in the multiple stages and a feedback operation unit 13 for supplying a feedback of the memorized output to the operation of the hash function operation unit 11 in the previous stage closer to the input than the output in the stage of the memorized output. The feedback operation unit 13 is adapted to set the feedback data as an initial operation parameter D5 of the hash function operation unit 11 and change the operation of the relevant hash function operation unit 11.

The feedback operation unit 13 may be adapted to operate the feedback data with the input of the hash function operation unit 11 and use a result of the operation as the input of the hash function operation unit 11.

Further, the feedback operation unit 13 may cover one or more than one hash function operation units 11.

In the present embodiment, the hash function operation processing device 10a, illegal access detecting device 20 and illegal access monitoring device 30 are incorporated in an LSI chip A5 in which the system program is actuated.

The hash function operation processing device 10a according to the present embodiment may be applied to the other preferred embodiments.

An actuation of the hash function operation system is described below.

The hash function operation processing device 10a retrieves the output of the hash operation unit 11 in an optional stage and memorizes the retrieved output in the hash function output memorizing unit 12. The memorized output is transmitted to the feedback operation unit 13. More specifically, the memorized output is immediately supplied as the feedback to the operation of the hash function operation unit 11 in the previous stage closer to the input than the output in the stage of the memorized output. The feedback operation unit 13 sets the feedback data as the initial operation parameter D5 of the hash function operation unit 11 and thereby changes the operation of the relevant hash function operation unit 11.

When the inputted value for operation Din is newly set in the input register by the system program after the sequence of processings are terminated and the operation is started by making the operation starting signal S1 effective, the output of the hash function operation processing device 10a depends on the operation value Din last inputted. More specifically, according to the present embodiment, the output of the hash function operation processing device 10a depends on the history of the inputted values for operation Din serially inputted at a certain point of time. The rest of the actuation, which is the same as described in the first preferred embodiment, is not described here again.

According to the present embodiment, the hash function operation processing device 10a is adapted to supply the feedback. Therefore, the information length used as the input for the hash function operation is free of any restriction, and the unique output having a fixed length can be obtained relative to the input of the optional information length, as a result of which the falsification can be detected in a long text and the encryption key can be generated based on the long-text data.

Further, the hash function operation unit 11 of the different system is used for each feedback because the feedback data is set as the initial operation parameter D5 of the hash function operation unit 11, and the operation of the hash function operation unit 11 is changed. As a result, it becomes more difficult to predict the hash function operation result Dout than in using a single hash function operation unit 11, which improves the security level.

### Sixth Preferred Embodiment

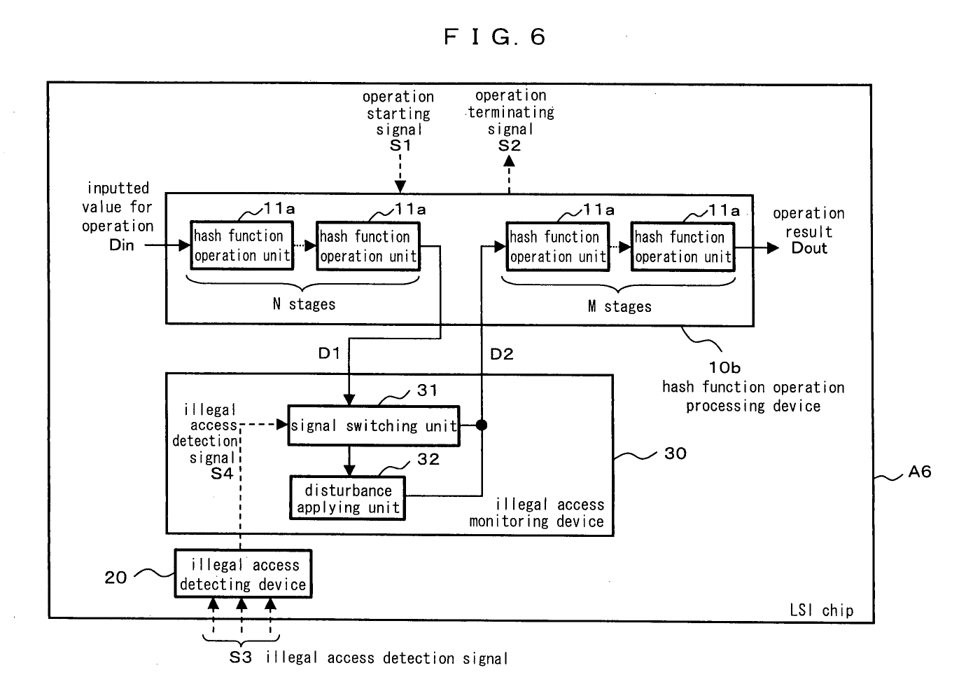

A sixth preferred embodiment of the present invention relates to a simplified encrypting apparatus in which different actuations are executed when the normal access is made and when the illegal access is made. A decoding apparatus according to the present embodiment shown in FIG. 6 is different to the first preferred embodiment shown in FIG. 1 in a constitution of a hash function operation unit la provided in a hash function operation processing device 10b. In FIG. 6, the illegal access monitoring device 30 and the illegal access detecting device 20 are constituted in the same manner as described in the first preferred embodiment.

In the hash function operation processing device 10b shown in FIG. 6, the information lengths of the input and the output are equal to each other, and the relationship between the input and the output is 1:1, and further, the hash function operation units 11a incapable of easily predicting the output from the input are connected in multiple stages. However, the hash function operation unit 11a provided therein includes an inverse function for obtaining the input from the output based on 1:1 and can execute the inverse function operation.

The illegal access detecting device 20 and the illegal access monitoring device 30 are constituted and actuated in the same manner as described in the first preferred embodiment.

In the present embodiment, the hash function operation processing device 10b, illegal access detecting device 20 and illegal access monitoring device 30 are incorporated in an LSI chip A6 in which the system program is actuated.

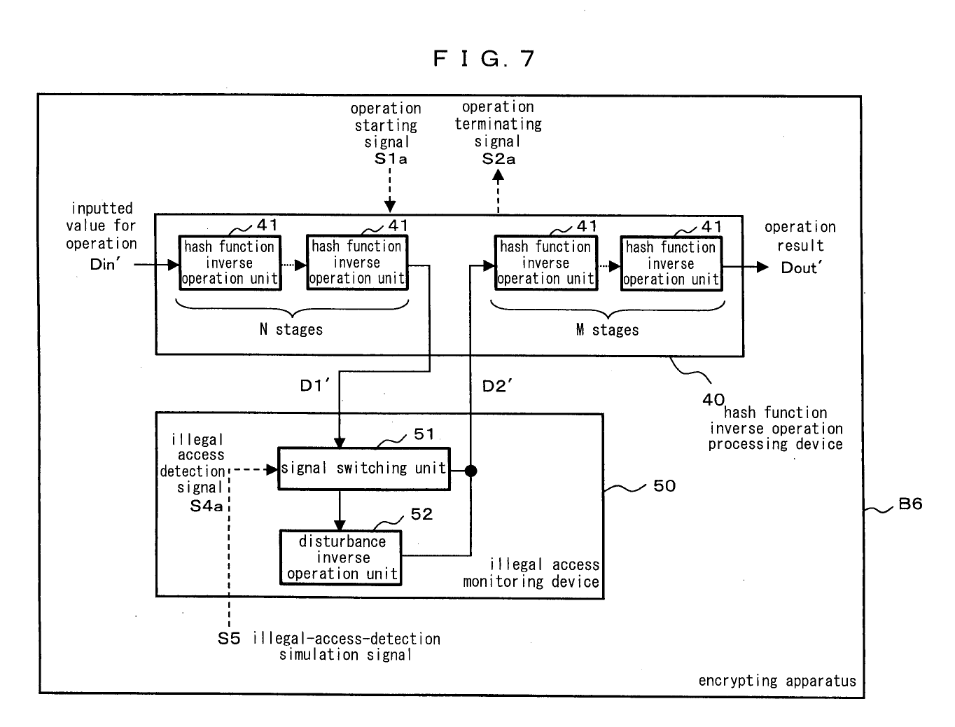

In FIG. 7, an encrypting apparatus B6 uses the inverse function of the hash function operation unit 11a to thereby obtain a desired output from the hash function operation processing device 10b. The encrypting apparatus B6 is a device for generating data that can be inputted to the hash function operation processing device 10b and memorizes the generated data in a memory or a file. A hash function inverse operation processing device 40 in the encrypting apparatus B6 comprises a plurality of hash function inverse operation units 41 connected in multiple stages, the hash function inverse operation units 41 executing the inverse function operations of the hash function operation units 11a of the hash function operation processing device 10b. The number of the stages of the hash function inverse operation units 41 in the encrypting apparatus B6 is equal to the number of the stages of the hash function operation units 11a in the hash function operation processing device 10b. A disturbance inverse operation unit 52 in an illegal access monitoring device 50 executes an operation of the input based on the output of the disturbance applying unit 32 in the illegal access monitoring device 30 in the LSI chip A6.

As an illegal access detection signal 4a inputted to the illegal access monitoring device 50 in the encrypting apparatus B6, an illegal-access-detection simulation signal S5 generated in a simulated manner in compliance with required conditions/specifications at the time of the decoding is used.

The hash function operation processing devices 10 and 10a in the second through fifth preferred embodiments may be replaced with the hash function operation processing device 10b according to the present embodiment.

An actuation according to the present embodiment is described below.

The hash function operation unit 11a in the decoding apparatus shown in FIG. 6 is basically actuated in the same manner as the hash function operation unit 11 according to the first preferred embodiment except for the inclusion of the inverse function and the capability of the inverse function operation.

In the encrypting apparatus B6 shown in FIG. 7, first, an inputted value for operation Din′ is set in the input register by the system program so that an operation starting signal S1a becomes effective. When the operation starts, the inputted value for operation Din′ is inputted to the hash function inverse operation unit 41 in the first stage. The output of the hash function inverse operation unit 41 in the first stage is inputted to the hash function inverse operation unit 41 in the next stage. Thus, the operations of the hash function inverse operation units 41 are serially executed. The output of the hash function inverse operation unit 41 in the final stage is consequently the output of the encrypting apparatus B6. An operation result Dout′ is set in the output register, and an operation terminating signal S2a is communicated to the system program.

It is necessary for the security of the encrypting apparatus B6 to be under the protection and management during its actuation. When the encrypting apparatus B6 itself is unrestrictedly used by an unidentified user or an internal structure thereof is made public, the simplified encrypting means according to the present embodiment is violated in terms of its security as generally called.

An input signal D1′ and an output signal D2′ are handled between the hash function inverse operation processing device 40 and the illegal access monitoring device 50, and the illegal access monitoring device 50 is actuated in the same manner as described in the first preferred embodiment.

According to the present embodiment, the hash function operation unit 11a is adapted to include the inverse function for obtaining the input from the output based on 1:1 and execute the inverse function operation, a person who knows the inverse operation method can generate the input of the hash function operation processing device 10b by arranging the output of the hash function operation processing device 10b into the plain-text data readable by a human and also arranges the generated input to be unreadable. More specifically, the data generated in the encrypting apparatus b6 and to be inputted to the hash function operation processing device 10b is the encrypted data that can be decoded by the hash function operation processing device 10b. When the decoding process is executed by the hash function operation processing device 10b, the detection of the illegal access does not allow the decoding process to be normally executed. Thereby, the encrypted data can be protected from any illegal access.

Further, the key management becomes unnecessary because the encryption key and the decoding key are not required in the present embodiment.

### Seventh Preferred Embodiment

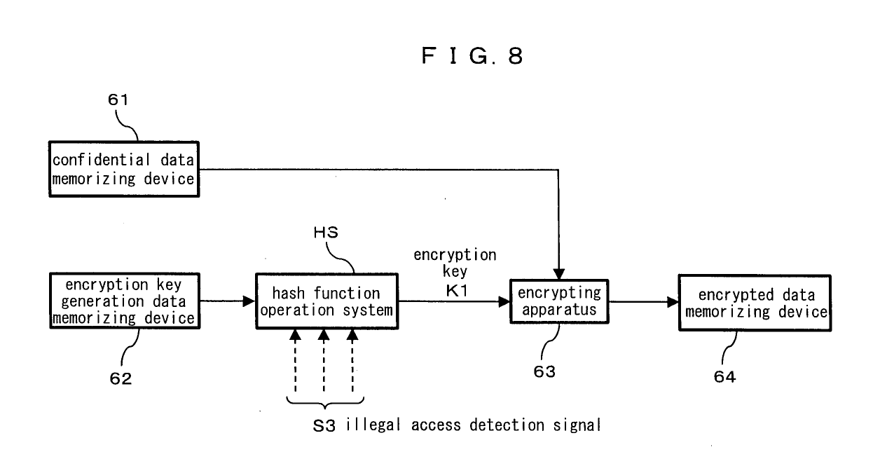

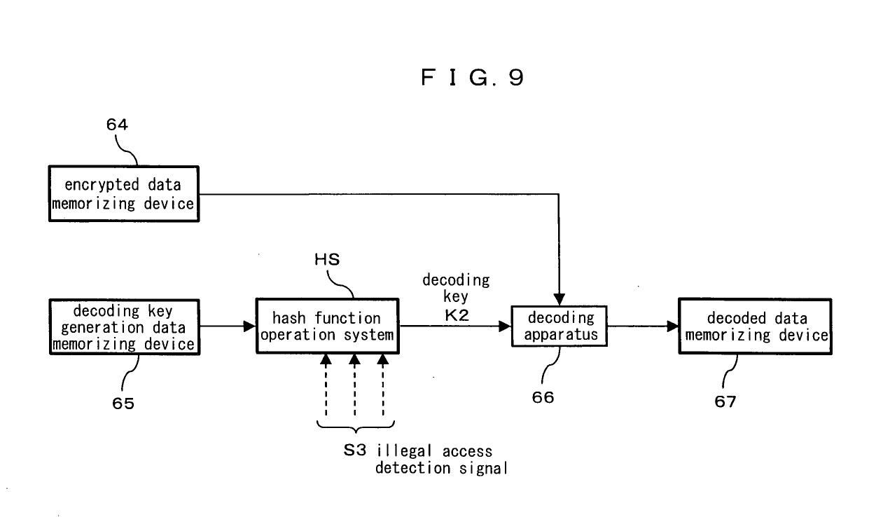

A seventh preferred embodiment of the present invention relates to an illegal analysis/falsification preventing system, which is described referring to FIGS. 8 and 9.

FIG. 8 is a block diagram illustrating a constitution of an illegal analysis/falsification preventing system relating to the encryption by means of a symmetry encryption system. The illegal analysis/falsification preventing system comprises a confidential data memorizing device 61 for memorizing a program or data to be confidentially protected, an encryption key generation data memorizing device 62 for storing a source data for generating an encryption key K1, a hash function operation system HS for generating the encryption key K1 by executing the hash function operation to the data of the encryption key generation data memorizing device 62, an encrypting apparatus 63 of the symmetry encryption system for encrypting the program or data from the confidential data memorizing device 61 using the encryption key K1 obtained from the hash function operation system HS, and an encrypted data memorizing device 64 for storing the encrypted data. Any of the hash function operation systems according to the first through fifth embodiments can be applied to the hash function operation system HS. The encrypting apparatus 63 employs the publicly known symmetry encryption system such as DES (Data Encryption Standard) and AES (Advanced Encryption Standard).

FIG. 9 is a block diagram illustrating a constitution of an illegal analysis/falsification preventing system relating to the decoding process by means of the symmetry encryption system. The illegal analysis/falsification preventing system comprises an encrypted data memorizing device 64 for memorizing an encrypted program or data, a decoding key generation data memorizing device 65 for storing a source data for generating a decoding key K2, a hash function operation system HS for generating the decoding key K2 (identical to encryption key K1) by executing the hash function operation to the data of the decoding key generation data memorizing device 65, a decoding apparatus 66 of the symmetry encryption system for decoding the encrypted data from the encrypted data memorizing device 64 using the decoding key K2 obtained from the hash function operation system HS, and a decoded data memorizing device 67 for storing the decoded program or data. Any of the hash function operation systems according to the first through fifth preferred embodiments can be applied to the hash function operation system HS. The decoding apparatus 66 employs the publicly known symmetry encryption system such as DES and AES.

An actuation of the illegal analysis/falsification preventing system according to the present embodiment is described below.

In the encryption process, as shown in FIG. 8, first, the system program reads the source data for generating the encryption key K1 from the encryption key generation data memorizing device 62, and inputs the read source data to the hash function operation system HS. Next, the system program starts the operation of the hash function operation system HS and thereby obtains the encryption key K1 as the output. Further, the system program reads the program or data desirably confidentially protected from the confidential data memorizing device 61 and inputs the read program or data to the encrypting apparatus 63 to thereby encrypt the inputted program or data using the encryption key K1 previously obtained. The encrypted program or data is stored in the encrypted data memorizing device 64.

For example, the illegal access detection signal S3 in the hash function operation system HS when the encryption is carried out is fixed to be ineffective (illegal access is not detected). However, the illegal access detection signal S3 is not necessarily fixed to be ineffective (illegal access is not detected) because the state of the illegal access detection signal S3 depends on the conditions and required specifications in the decoding process.

In the decoding process, as shown in FIG. 9, first, the system program reads the source data for generating the decoding key K2 (identical to encryption key K1) from the decoding key generation data memorizing device 65, and inputs the read source data to the hash function operation system HS. Next, the system program starts the operation of the hash function operation system HS and thereby obtains the decoding key K2 as the output. Further, the system program reads the encrypted program or data from the encrypted data memorizing device 64 and inputs the read program or data to the decoding apparatus 66 to thereby decode the inputted program or data using the decoding key K2 previously obtained. The decoded program or data is stored in the decoded data memorizing device 67.

When the decoding key K2 is generated in the hash function operation system HS, the correct decoding key is not obtained and the encrypted program or data thereby cannot be decoded in the presence of the illegal access. As the source data for generating the keys memorized in the encryption key generation data memorizing device 62 and the decoding key generation data memorizing device 65, random data or data that cannot be encrypted such as a system initial activation program is used. When the used data undergoes the falsification, the correct key cannot be generated. As a result, it becomes impossible to illegally falsify the source data used for generating the keys memorized in the encryption key generation data memorizing device 62 and the decoding key generation data memorizing device 65, and the source data is thereby protected.

In the illegal analysis/falsification preventing system according to the present embodiment, the confidential program or data can be safely decoded because the normal encryption key or the normal decoding key cannot be generated when the illegal access is detected, while the normal encryption key or the normal decoding key can be generated when the illegal access is not detected. The source data used for the generation of the encryption key or the decoding key can be left in the memory or file, which makes it unnecessary to confidentially manage the encryption key or the decoding key.

### Eighth Preferred Embodiment

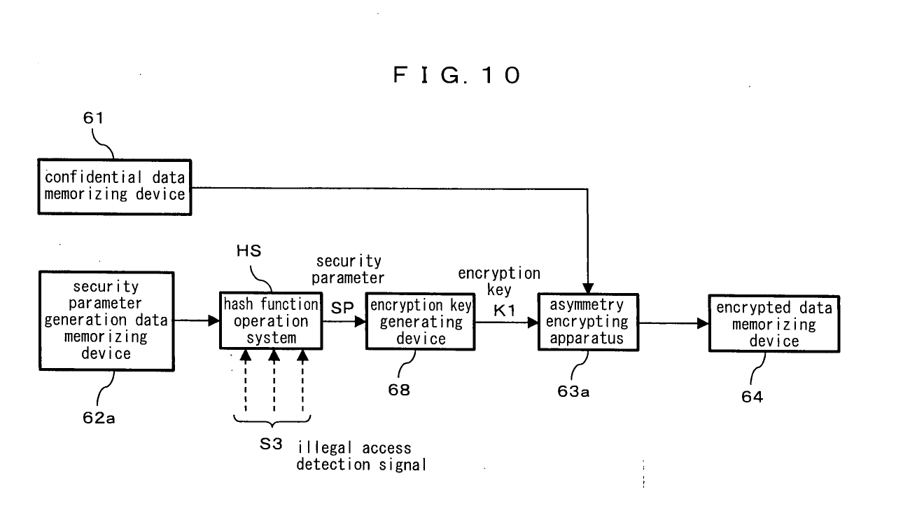

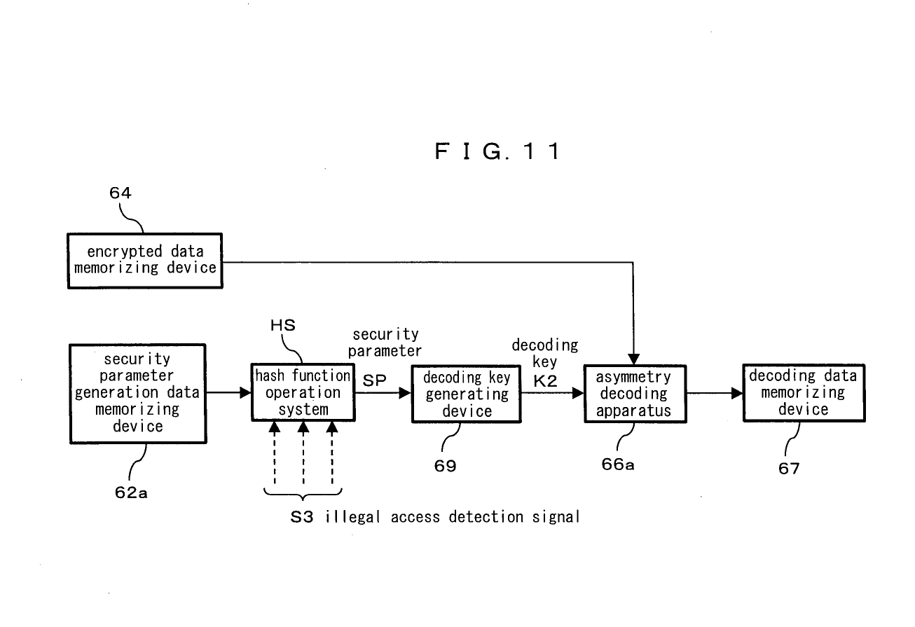

An illegal analysis/falsification preventing system according to an eighth preferred embodiment of the present invention is described referring to FIGS. 10 and 11.

FIG. 10 is a block diagram illustrating a constitution of an illegal analysis/falsification preventing system relating to the encryption by means of an asymmetry encryption system. The illegal analysis/falsification preventing system comprises a confidential data memorizing device 61 for memorizing a program or data desirably confidentially protected, a security parameter generation data memorizing device 62a for memorizing a source data (seed) for generating a security parameter SP used for the generation of a pair of keys in the asymmetry encryption system, a hash function operation system HS for executing the hash function operation to the data of the security parameter generation data memorizing device 62a and generating the security parameter SP, an encryption key generating device 68 for generating the encryption key K1 based on the security parameter SP obtained from the hash function operation system HS, wherein the encryption key is generated by selecting or fixing one of a public key and a secret key based on a user's input or initial settings, an asymmetry encrypting apparatus 63a of the asymmetry encryption system for encrypting the program or data from the confidential data memorizing device 61 using the encryption key K1 obtained from the encryption key generating device 68, and an encrypted data memorizing device 64 for storing the encrypted data. Any of the hash function operation systems according to the first through fifth preferred embodiments can be applied to the hash function operation system HS. The asymmetry encrypting apparatus 63a employs a publicly known asymmetry encryption system such as the RSA public key encryption system.

FIG. 11 is a block diagram illustrating a constitution of an illegal analysis/falsification preventing system relating to the decoding process by means of the asymmetry encryption system. The illegal analysis/falsification preventing system comprises an encrypted data memorizing device 64 for memorizing a program or data asymmetry-encrypted, a security parameter generation data memorizing device 62a for memorizing a source data (seed) for generating a security parameter SP used for the generation of a pair of keys in the asymmetry encryption system, a hash function operation system HS for executing the hash function operation to the data of the security parameter generation data memorizing device 62a and generating the security parameter SP, a decoding key generating device 69 for generating the decoding key K2 based on the security parameter SP obtained from the hash function operation system HS, an asymmetry decoding apparatus 66a of the asymmetry encryption system for decoding the encrypted program or data from the encrypted data memorizing device 64 using the decoding key K2 obtained from the decoding key generating device 69, and a decoded data memorizing device 67 for storing the decoded program or data. Any of the hash function operation systems according to the first through fifth preferred embodiments can be applied to the hash function operation system HS. The asymmetry decoding apparatus 66a employs the publicly known asymmetry encryption system such as the RSA public key encryption system.

An actuation of the illegal analysis/falsification preventing system according to the present embodiment is described below.

In the decoding process, as shown in FIG. 10, first, the system program reads the source data for generating the security parameter SP from the security parameter generation data memorizing device 62a, and inputs the read source data to the hash function operation system HS. Next, the system program starts the operation of the hash function operation system HS and inputs the outputted security parameter SP to the encryption key generating device 68 to thereby obtain the encryption key K1 as the output of the encryption key generating device 68. Further, the system program reads the program or data desirably confidentially protected from the encrypted data memorizing device 61 and inputs the read program or data to the asymmetry encrypting apparatus 63a to thereby encrypt the program or data using the encryption key K1 previously obtained. The encrypted program or data is stored in the encrypted data memorizing device 64.

For example, the illegal access detection signal S3 in the hash function operation system HS when the encryption is carried out is fixed to be ineffective (illegal access is not detected). However, the illegal access detection signal S3 is not necessarily fixed to be ineffective (illegal access is not detected) because the state of the illegal access detection signal S3 depends on the conditions and required specifications in the decoding process.

In the decoding process, as shown in FIG. 11, first, the system program reads the source data for generating the security parameter SP from the security parameter generation data memorizing device 62a, and inputs the read source data to the hash function operation system HS. Next, the system program starts the operation of the hash function operation system HS and inputs the outputted security parameter SP to the decoding key generating device 69 to thereby obtain the decoding key K2 as the output of the decoding key generating device 69. Further, the system program reads the encrypted program or data from the encrypted data memorizing device 64 and inputs the read program or data to the asymmetry encrypting apparatus 66a to thereby decode the program or data using the decoding key K2 previously obtained. The decoded program or data is stored in the decoded data memorizing device 67.

When the security parameter SP used as the source data for the generation of the decoding key K2 is generated in the hash function operation system HS, the correct security parameter SP is not obtained and the encrypted program or data cannot be decoded in the presence of the illegal access. As the source data of the security parameter SP memorized in the security parameter generation data memorizing device 62a, the random data or the data that cannot be encrypted such as the system initial activation program is used. When the used data undergoes the falsification, the correct security parameter SP cannot be generated. As a result, it becomes impossible to illegally falsify the source data used for generating the security parameter memorized in the security parameter generation data memorizing device 62a, and the source data is thereby protected.

In the illegal analysis/falsification preventing system according to the present embodiment, the confidential program or data can be safely decoded because the normal encryption key or the normal decoding key cannot be generated when the illegal access is detected, while the normal encryption key or the normal decoding key can be generated when the illegal access is not detected. The source data used for the generation of the encryption key or the decoding key can be left in the memory or file, which makes it unnecessary to confidentially manage the encryption key or the decoding key Further, according to the present embodiment, the encrypting function or the decoding function can be restrictedly used in the same system because the asymmetry encryption system is used. If, by any chance, the decoded data is illegally retrieved, the retrieved data cannot be falsified and re-encrypted in the system, which effectively prevents the illegal modification of the system itself.

### Ninth Preferred Embodiment

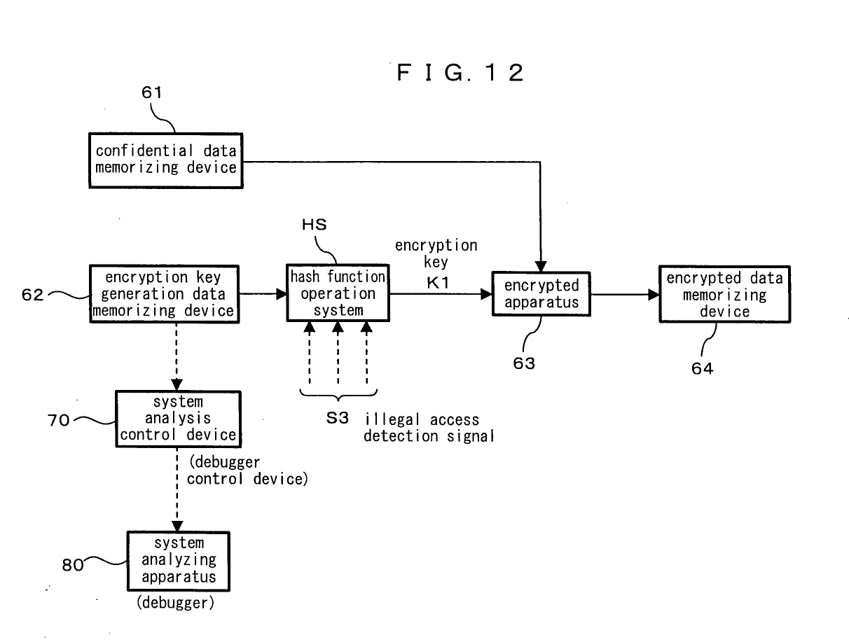

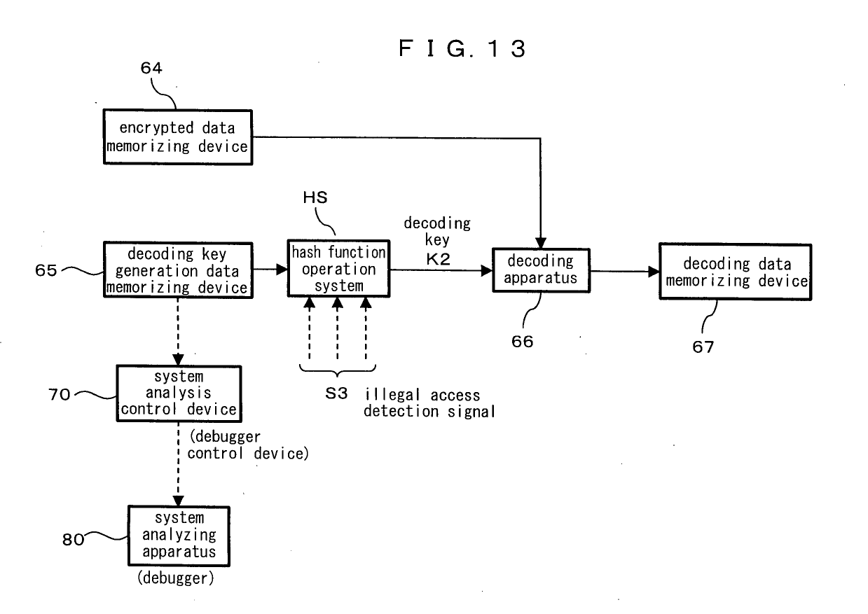

FIGS. 12 and 13 respectively show an illegal analysis/falsification preventing system according to a ninth preferred embodiment of the present invention comprising an encrypting apparatus that differently actuates when the normal access is made and when the illegal access is generated and a function of accepting or rejecting a system analyzing apparatus such as a debugger or a tracer.

FIG. 12 is a block diagram illustrating a constitution of an illegal analysis/falsification preventing system relating to the encrypting process by means of the symmetry encryption system. The illegal analysis/falsification preventing system comprises a confidential data memorizing device 61 for memorizing a program or data desirably confidentially protected, an encryption key generation data memorizing device 62 for storing a source data for generating the encryption key K1, a system analysis control device (debugger control device) 70 for utilizing a program executed before the program and data to be confidentially protected as the source data for generating the encryption key K1, the program including execution codes for switching to and from effective and ineffective of a debugger analyzing function with respect to a system analyzing apparatus (debugger) 80, a hash function operation system HS for generating the encryption key K1 by executing the hash function operation to the data of the encryption key generation data memorizing device 62, an encrypting apparatus 63 of the symmetry encryption system for encrypting the program or data from the confidential data memorizing device 61 using the encryption key K1 obtained from the hash function operation system HS, and an encrypted data memorizing device 64 for storing the encrypted data. The encrypting apparatus 63 employs the publicly known symmetry encryption system such as DES and AES.

As shown in FIG. 13, the execution of the decoding process includes an encrypted data memorizing device 64 for memorizing the encrypted program or data, a decoding key generation data memorizing device 65 for storing the source data for generating the decoding key K2 identical to the encryption key K1, a system analysis control device 70 for utilizing a program executed before the program or data to be confidentially protected as the source data for generating the decoding key K2, the program including execution codes for switching to and from effective and ineffective of the debugger analyzing function with respect to the system analyzing apparatus (debugger) 80, a decoding apparatus 66 for executing the decoding process using the decoding key K2 identical to the encryption key K1, and a decoded data memorizing device 67 for storing the decoded program or data. The decoding apparatus 66 employs the publicly known symmetry encryption system such as DES and AES.

Any of the hash function operation system according to the first through fifth embodiments can be applied to the hash function operation system.

The encryption system used in the present embodiment is not limited to the symmetry encryption system, and the asymmetry encryption system as in the eighth preferred embodiment can be used instead.

In the decoding process, the execution codes for switching to and from effective and ineffective of the debugger analyzing function with respect to the system analyzing apparatus 80 may be stored in a confidential program memorized in the encrypted data memorizing device 64.

An actuation of the illegal analysis/falsification preventing system according to the present embodiment is described below.

When the encryption is carried out, as shown in FIG. 12, first, the program memorized in the system analysis control device 70 and including the execution codes for switching to and from effective and ineffective of the debugger analyzing function with respect to the system analyzing apparatus (debugger) 80 is executed so that the debugger analyzing function is deactivated. Next, the system program confirms the debugger in the deactivated state, and thereafter generates the data or program to be confidentially protected and stores the generated program or data in the confidential data memorizing device 61. Next, the system program reads the source data for generating the encryption key K1 from the encryption key generation data memorizing device 62 and inputs the read source data to the hash function operation system HS. Then, the system program starts the operation of the hash function operation system HS to thereby obtain the encryption key K1 as the output. Further, the system program reads the confidential program or data from the confidential data memorizing device 61 and inputs the read program or data to the encrypting apparatus 63 to thereby encrypt the program or data using the encryption key K1 previously obtained. The encrypted program or data is stored in the encrypted data memorizing device 64. Further, when necessary, the system program may execute the execution code for activating the debugger analyzing function with respect to the system analyzing apparatus 80 after the encryption of the confidential program or data.

For example, the illegal access detection signal S3 in the hash function operation system HS when the decoding is carried out is fixed to be ineffective (illegal access is not detected). However, the illegal access detection signal S3 is not necessarily fixed to be ineffective (illegal access is not detected) because the state of the illegal access detection signal S3 depends on the conditions and required specifications in the decoding process.

As shown in FIG. 13, when the decoding process is carried out, first, the program memorized in the system analysis control device 70 and including the execution codes for switching to and from effective and ineffective of the debugger analyzing function with respect to the system analyzing apparatus 80 is executed so that the debugger analyzing function is deactivated. Next, the system program reads the source data for generating the decoding key K2 from the decoding key generation data memorizing device 65 and inputs the read source data to the hash function operation system HS. Then, the system program starts the operation of the hash function operation system HS to thereby obtain the decoding key K2 as the output. Further, the system program reads the encrypted program or data from the encrypted data memorizing device 64 and inputs the read program or data to the decoding apparatus 66 to thereby decode the program or data using the decoding key K2 previously obtained. The decoded program or data is stored in the decoded data memorizing device 67. Further, when necessary, the system program may erase the decoded program or data after it is used and execute the execution code for activating the debugger analyzing function with respect to the system analyzing apparatus 80.

When the decoding key K2 is generated in the hash function operation system HS, the correct decoding key is not obtained and the encrypted program or data cannot be decoded in the presence of the illegal access. Further, the correct key cannot be generated when the program as the source for generating the key memorized in the system analysis control device 70 is falsified. As a result, it becomes impossible to illegally falsify the program as the source for generating the key memorized in the system analysis control device 70, and the program as the source data is thereby protected.

According to the present embodiment, the normal encryption key or decoding key cannot be generated when the illegal access is detected, while the normal encryption key or decoding key can be generated when the illegal access is not detected. Therefore, the confidential program or data can be safely decoded. Further, the data as the source for generating the encryption key or the decoding key can be left in the memory or file, which makes the confidential management of the encryption key or the decoding key unnecessary.

Further, according to the present embodiment, when the confidential data generated in the process of executing the system program is encrypted, the system analyzing apparatus such as the debugger can be deactivated, which makes the encryption safely executed.

Further, the illegal analysis and the illegal falsification of the plain-text data resulting from decoding the encrypted data can be restricted. As a result, the plain-text data resulting from normally decoding the encrypted confidential data can be protected.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A hash function operation system comprising:
a hash function operation processing device comprising a plurality of hash function operation units connected in multiple stages and adapted in such manner that information lengths of an inputted value for operation and a value resulting from the operation are equal to each other and the inputted value for operation and the value resulting from the operation correspond to each other based on 1:1;
an illegal access detecting device for detecting an illegal access from outside when the hash function operation processing device executes an operation;
an illegal access monitoring device for retrieving an output of an optional stage in a sequence of processings executed by the hash function operation units connected in the multiple stages and inputting the retrieved output to the hash function operation unit in a next stage when the illegal access detecting device shows a state where the illegal access is not detected, the illegal access monitoring device further applying a disturbance to the retrieved output when the illegal access detecting device shows a state where the illegal access is detected and inputting the resulting output to the hash function operation unit in the next stage.

2. A hash function operation system as claimed in claim 1, wherein
the hash function operation processing device comprises:
a previous-stage hash function operation processing device comprising at least a hash function operation unit serially connected, the previous-stage hash function operation processing device transmitting an output of the hash function operation unit in a final stage to the illegal access monitoring device; and
a latter-stage hash function operation processing device comprising at least a hash function operation unit serially connected, the latter-stage hash function operation processing device inputting a signal transmitted from the illegal access monitoring device to the hash function operation unit in a foremost stage and outputting an operation result obtained by the hash function operation unit in the final stage outside.

3. A hash function operation system as claimed in claim 1, wherein
the illegal access monitoring device is adapted to apply a disturbance different to the disturbance applied in the state where the illegal access is detected to the retrieved output when the illegal access detecting device shows the state where the illegal access is not detected and inputs the resulting output to the hash function operation unit in the next stage.

4. A hash function operation system as claimed in claim 1, wherein
the illegal access detecting device is adapted in such manner that the state where the illegal access is not detected shifts to the state where the illegal access is detected or the state where the illegal access is detected shifts to the state where the illegal access is not detected based on a history of the illegal accesses since the system is activated.

5. A hash function operation system as claimed in claim 1, wherein
the illegal access monitoring device comprises:
a password memorizing unit for memorizing passwords; and
a password comparing unit for comparing an output of the illegal access monitoring device to the passwords of the password memorizing unit, wherein
the actuation of the illegal access detecting device is adapted to switch to and from a constantly detected state, a constantly not-detected state and an illegal access detected state depending on a state of correspondence between the passwords and the output.

6. A hash function operation system as claimed in claim 5, wherein
the illegal access monitoring device compares the passwords to the output when the output of the illegal access monitoring device is stored/memorized to such an extent that an optional information length is reached.

7. A hash function operation system as claimed in claim 1, wherein
the hash function operation processing device further comprises:
a hash function output memorizing unit for retrieving and memorizing the output from the hash function operation unit in an optional stage; and
a feedback operation unit for executing an optional operation to the memorized output and the input of the hash function operation unit in a previous stage closer to the input than the output in the stage of the memorized output.

8. A hash function operation system as claimed in claim 1, wherein
the hash function operation processing device further comprises:
an initial operation parameter memorizing unit for memorizing an initial operation parameter used for the hash function operation other than the input and the output;
a hash function output memorizing unit for retrieving and memorizing the output of the hash function operation unit in an optional stage; and
a feedback operation memorizing unit for executing an optional operation to the memorized output and the initial operation parameter of the hash function operation unit in a previous stage closer to the input than the output in the stage of the memorized output and memorizing a result of the operation as a renewed initial operation parameter.

9. A hash function operation system as claimed in claim 1, wherein
the hash function operation unit is adapted to include an inverse function for obtaining an input from an output based on 1:1 and be capable of executing an inverse operation by obtaining an input from an output of a hash function inverse operation processing device.

10. An encryption system comprising:
a hash function inverse operation processing device capable of executing an inverse operation and comprising a plurality of hash function inverse operation units connected in multiple stages, the hash function inverse operation units performing an inverse function relative to the hash function operation units; and
an illegal access monitoring device for retrieving an output of an optional stage in a sequence of processings executed by the hash function inverse operation units connected in the multiple stages and inputting the retrieved output to the hash function inverse operation unit in a next stage in a state where an illegal access is not detected, the illegal access monitoring device further applying a disturbance to the retrieved output in a state where the illegal access is detected and inputting the resulting output to the hash function inverse operation unit in the next stage.

11. An illegal analysis/falsification preventing system comprising:
a confidential data memorizing device for memorizing a program or data to be confidentially protected;
an encryption key generation data memorizing device for memorizing a source data for generating an encryption key used in a symmetry encryption system;
a hash function operation system according to claims 1, the hash function operation system inputting the data of the encryption key generation data memorizing device and generating the encryption key using the hash function operation; and
a symmetry encrypting apparatus for encrypting the data or program to be confidentially protected in the confidential data memorizing device by means of the symmetry encryption system using the encryption key obtained from the hash function operation system.

12. An illegal analysis/falsification preventing system comprising:
an encrypted data memorizing device for memorizing symmetry-encrypted data;
a decoding key generation data memorizing device for memorizing a source data for generating a decoding key used for a decoding process by means of the symmetry encryption system;
a hash function operation system according to claims 1, the hash function operation system inputting the data of the decoding key generation data memorizing device and generating the decoding key using the hash function operation; and
a symmetry encryption decoding apparatus for decoding the encrypted data of the encrypted data memorizing device by means of the symmetry encryption system using the decoding key obtained from the hash function operation system.

13. An illegal analysis/falsification preventing system comprising:
a confidential data memorizing device for memorizing a program or data to be confidentially protected;
a security parameter generation data memorizing device for memorizing a source data for generating a security parameter used for generating a pair of keys in the asymmetry encryption system;
a hash function operation system according to claims 1, the hash function operation system inputting the data of the security parameter generation data memorizing device and generating the security parameter using the hash function operation;
an encryption key generating device for generating an encryption key based on the security parameter using the hash function operation system, the encryption key generating device generating the encryption key by selecting or fixing one of a public key and a secret key based on a user's input or initial settings; and
an asymmetry encrypting apparatus for encrypting the data or program to be confidentially protected in the confidential data memorizing device by means of the asymmetry encryption system using the encryption key obtained from the encryption key generating device.

14. An illegal analysis/falsification preventing system comprising:
an encrypted data memorizing device for memorizing asymmetry-encrypted data;
a confidential data memorizing device for memorizing a program or data to be confidentially protected;
a security parameter generation data memorizing device for memorizing a source data for generating a security parameter used for generating a pair of keys in the asymmetry encryption system;
a hash function operation system according to claims 1, the hash function operation system inputting the data of the security parameter generation data memorizing device and generating the security parameter using the hash function operation;
a decoding key generating device for generating a decoding key based on the security parameter obtained by the hash function operation system, the decoding key generating device generating the decoding key by selecting or fixing one of a public key and a secret key based on a user's input or initial settings; and
an asymmetry encryption decoding apparatus for decoding the data or program to be confidentially protected in the confidential data memorizing device by means of the asymmetry encryption system using the decoding key obtained from the decoding key generating device.

15. An illegal analysis/falsification preventing system as claimed in claim 11, further comprising a system analysis control device for accepting or rejecting a system analyzing apparatus such as a debugger or a tracer and using program data as the source data for generating the encryption key used for the symmetry encryption system, the program data including codes for controlling the acceptance or the rejection of the system analyzing apparatus therein.

16. An illegal analysis/falsification preventing system as claimed in claim 12, further comprising a system analysis control device for accepting or rejecting a system analyzing apparatus such as a debugger or a tracer and using program data as the source data for generating the decoding key used for the decoding process by means of the symmetry encryption system, the program data including codes for controlling the acceptance or the rejection of the system analyzing apparatus therein.

17. An illegal analysis/falsification preventing system as claimed in claim 13, further comprising a system analysis control device for accepting or rejecting a system analyzing apparatus such as a debugger or a tracer and using program data as the source data for generating the security parameter used for the asymmetry encryption system, the program data including codes for controlling the acceptance or the rejection of the system analyzing apparatus therein.

18. An illegal analysis/falsification preventing system as claimed in claim 14, further comprising a system analysis control device for accepting or rejecting a system analyzing apparatus such as a debugger or a tracer and using program data as the source data for generating the security parameter used for the decoding process by means of the asymmetry encryption system, the program data including codes for controlling the acceptance or the rejection of the system analyzing apparatus therein.
